(19) United States
(12) Patent Application Publication
(10) Pub. No.: US 2008/0034304 A1
(43) Pub. Date: Feb. 7, 2008

(54) Method, System, and Program Product for Focus Switching Delay in a Graphical User Interface

(76) Inventors: Frank P. Feuerbacher, Austin, TX (US); John D. Hannon, Austin, TX (US); Virgil Itliong, Cedar Park, TX (US); Rolf Kocheisen, Pflugerville, TX (US); Brian D. Nelson, Austin, TX (US); Michael W. Panico, Austin, TX (US); Vijayanand Vinnakota, Round Rock, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/461,957

(22) Filed: Aug. 2, 2006

(51) Int. Cl. G06F 9/00

(52) U.S. Cl. 715/764; 715/802; 715/781; 715/804

(57) ABSTRACT

In a data processing system having an associated display device and a graphical user interface presented therein, a focus change request is received from an application of the data processing system requesting focus of the graphical user interface. In response to receipt of the focus change request, granting of the focus change request is delayed for a predetermined interval following a last user-generated keyboard event. Following elapsing of the predetermined interval, the focus change request is granted, such that the requesting application is awarded focus of the graphical user interface.

### BACKGROUND OF THE INVENTION

1. Technical Field

The present invention relates in general to the field of computers and other data processing systems, and in particular to Graphical User Interfaces (GUIs). Still more particularly, the present invention pertains to controlling the keyboard focus of a GUI.

2. Description of the Related Art

Personal computer systems typically utilize a Graphical User Interface (GUI) to facilitate the communication of data between the computer and a user. Conventional GUIs, such as that provided by the Windows® operating system, permit a plurality of concurrently presented components (e.g., windows), but can only accommodate keyboard input from the user for one GUI component (e.g., window) at a time. The GUI component from which input is currently received is said to have the “focus”. GUIs thus provide the ability for software applications to automatically switch the keyboard focus from one graphical component (e.g., window) to another. Furthermore, keyboard focus may be changed between two components in the same application or between components in separate applications.

User frustration may arise when the computer system automatically switches the keyboard focus to a particular GUI component while the user is actively interacting with (e.g., typing data into) another component of the same or a different software application. If the user is actively entering keyboard input when the keyboard focus shifts, the user may not immediately notice that the keyboard focus has changed and may accidentally key data into another GUI component. For example, when a pop-up window is displayed while the user is in the process of typing text into a document, the pop-up window may obtain the keyboard focus and respond to any subsequent keyboard input that the user types, which may produce undesirable results (e.g., dismissing the pop-up window before the user has read the contents or initiating an unintended operation).

Some conventional computer systems do employ applications, such as the “Tweak UI” application from Microsoft Corporation of Redmond, Wash., that allow a user to disable the capability of an application to grab the keyboard focus from another application. However, completely disabling the keyboard focus switching capability is inefficient and may cause the user additional work due to the need to actively control the location of the keyboard focus. The present invention thus recognizes that there is a need for an improved method and system to control the keyboard focus of a GUI.

### SUMMARY OF THE INVENTION

In a data processing system having an associated display device and a graphical user interface presented therein, a focus change request is received from an application of the data processing system requesting focus of the graphical user interface. In response to receipt of the focus change request, granting of the focus change request is delayed for a predetermined interval following a last user-generated keyboard event. Following elapsing of the predetermined interval, the focus change request is granted, such that the requesting application is awarded focus of the graphical user interface.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary data processing system, as utilized in an embodiment of the present invention;

FIG. 2A is a high level logical flowchart of an exemplary process for recording the timestamp of a most recent keyboard event;

FIG. 2B is a high level logical flowchart of an exemplary processor for buffering keyboard focus change requests; and

FIG. 2C is a high level logical flowchart of an exemplary method of managing changes in keyboard focus in accordance with one embodiment of the invention.

### DETAILED DESCRIPTION OF AN ILLUSTRATIVE EMBODIMENT

The present invention provides a method, system, and computer program product for controlling the keyboard focus of a Graphical User Interface (GUI) within a computer or other data processing system.

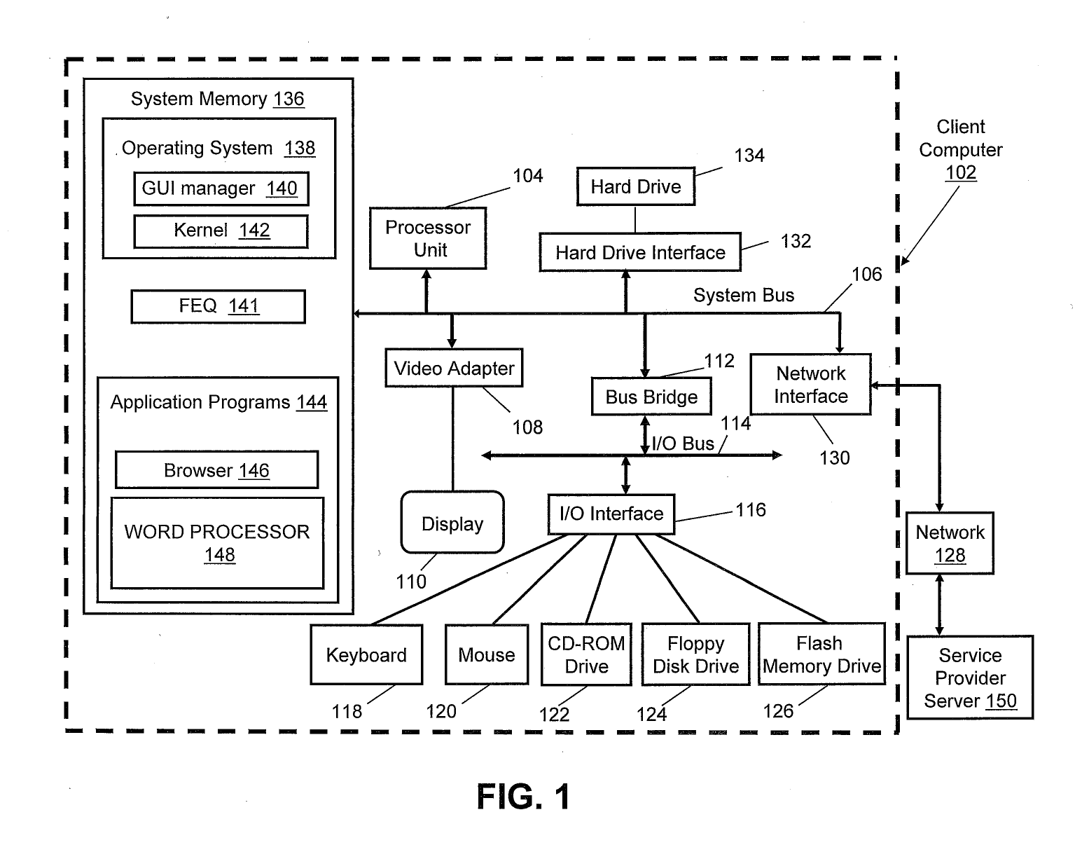

With reference now to FIG. 1, there is depicted a block diagram of an exemplary client computer 102, with which the present invention may be utilized. Client computer 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 202 via a network 128 using a network interface 130, which is coupled to system bus 106. Network 128 may be an external network such as the Internet, or an internal network such as an Ethernet or a Virtual Private Network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes client computer 102's operating system (OS) 138 and application programs 144.

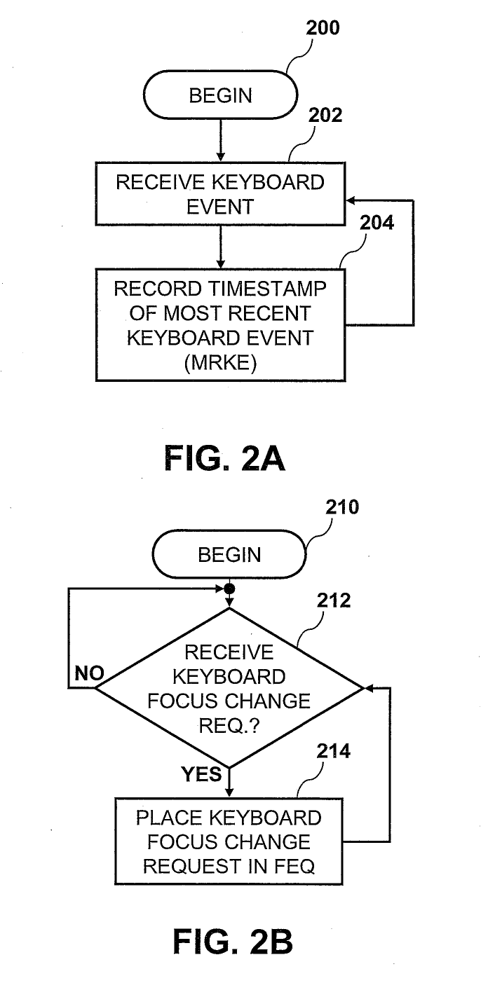

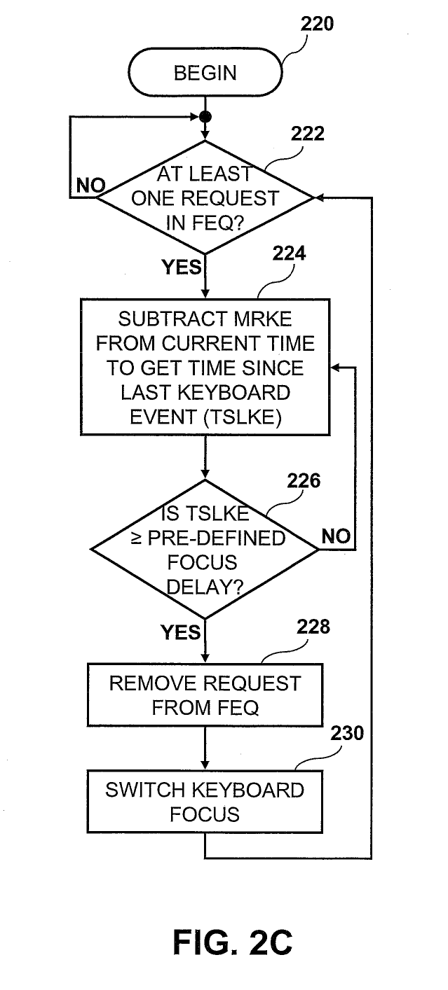

OS 138 includes a graphical user interface (GUI) manager 140, for providing transparent user access to resources, such as hardware components, communication ports, and application programs 144. Generally, GUI manager 140 provides a windowing environment and a graphical cursor (e.g., arrow) presented within display 110. GUI manager 140 interprets commands entered by keyboard, mouse, or other user input device, and sends the interpreted command(s) to the appropriate lower levels of the operating system (e.g., a kernel 142) for processing. GUI manager 140 also arbitrates between application programs 144 for control of the keyboard focus, as described further below with reference to FIG. 2.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 150. Application programs 144 may further include any number of other conventional applications, such as word processor 148. Browser 146 and word processor 148 preferably both employ the graphical interface supported by GUI manager 140 of operating system 138.

The hardware elements depicted in client computer 102 are not intended to be exhaustive, but rather are representative to highlight certain components that mat be utilized to practice the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

With reference now to FIGS. 2A-2C, there are depicted high level logical flowcharts of exemplary processes concurrently implemented by GUI manager 140 of operating system 138 to manage keyboard focus in accordance with the present invention. Referring specifically to FIG. 2A, there is illustrated an exemplary process for recording keyboard events in accordance with one embodiment of the present invention. The illustrated process begins at block 200, for example, in response to a user booting client computer 102 and invoking operation of applications programs 144, such as browser 146 and word processor 148. During execution of application programs 144, the user typically interacts with application programs 144 utilizing a pointing device, such as mouse 120, and keyboard 118. Each time the user depresses or releases a key of keyboard 118, operating system 138 receives a “keyboard event” signifying the change in state of the key, as shown at block 202 of FIG. 2A. In response, GUI manager 140 records the timestamp of the keyboard event in a storage location in system memory 136 allocated to the most recent keyboard event (MRKE), overwriting the timestamp of the previous keyboard event (block 204 of FIG. 2A). Operating system 138 generally also provides the keyboard event to the relevant application program 144, so that the application program 144 may respond appropriately, for example, by presenting an indicated character within display 110 or by executing a command. As indicated, the process of FIG. 2A continues iteratively during execution of operating system 138.

With reference now to FIG. 2B, there is depicted a high level logical flowchart of an exemplary method of buffering keyboard focus change requests in accordance with one embodiment of the invention. The depicted method begins at block 210 and then proceeds to block 212, which illustrates GUI manager 140 iterating until it receives a keyboard focus change request from an application program 144 within system memory 136. The keyboard focus change request requests focus for a particular graphical component of the graphical user interface supported by GUI manager 140, where the component for which focus is request can be associated with the same or different application than currently has the focus.

In response to receipt of a keyboard focus change request, GUI manager 140 buffers the keyboard focus change request within a focus event queue (FEQ) 141 within system memory 136. FEQ 141 can be advantageously implemented as an ordered queue, such as a first-in-first-out (FIFO) queue. Thereafter, the process returns to block 212.

Referring now to FIG. 2C, there is illustrated a high level logical flowchart of an exemplary method of managing changes in keyboard focus in accordance with one embodiment of the invention. The process begins at block 220 and then proceeds to block 222, which illustrates GUI manager 140 iterating until at least one keyboard focus change request is present within FEQ 141. If a keyboard focus change request is present within FEQ 141, the process proceeds to block 224. At block 224, GUT manager 140 subtracts the timestamp of the MRKE from the current time, which is obtained from the clock of client computer 102, to calculate the time since the last keyboard event (TSLKE).

At block 226, GUT manager 140 determines whether or not the TSLKE is greater than or equal to a focus delay that has been pre-defined by a user of client computer 102 or by operating system 140, where the focus delay is the desired time, for example, as measured in seconds or microseconds, that must elapse after the most recent keyboard event (MRKE) before GUT manager 140 will permit the keyboard focus to change to a different GUI component. If GUT manager 140 determines at block 215 that the TSLKE is greater than or equal to the predetermined focus delay, the process passes directly to block 228, which is described below. If, on the other hand, GUT manager 140 determines at block 226 that the TSLKE is less than the predetermined focus delay, the process returns to block 224.

Block 228 illustrates GUT manager 140 removing the oldest keyboard focus change request from FEQ 141. GUT manager 140 then grants the keyboard focus change request removed from FEQ 141, allowing the keyboard focus to switch to the specified GUI component of the requesting application program 144. Thereafter, the process returns to block 222, which has been described.

As has been described, the present invention provides a method, system, and computer program product for managing the keyboard focus of a Graphical User Interface (GUI) within a computer or other data processing system. In one embodiment, the method includes receiving a keyboard focus change request from an application, delaying the granting of the focus change request for a predetermined interval since a last user-generated keyboard event, and then granting the focus change request. Delayed focus change requests are preferably buffered in an ordered manner until the interval equal to the focus delay has elapsed.

While the invention has been particularly shown and described with reference to a preferred embodiment, it will be understood by those skilled in the art that various changes in form and detail may be made therein without departing from the spirit and scope of the invention. For example, it should be understood that the use herein of specific names are not intended to imply any limitations on the invention. The invention may thus be implemented with different nomenclature/terminology and associated functionality utilized to describe the above devices/utility, etc., without limitation. In addition, while an illustrative embodiment of the present invention has been described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of computer readable medium used to actually carry out the distribution. Examples of computer readable media include recordable type media such as flash drives, floppy disks, hard drives, CD-ROMs, DVDs, and transmission media such as digital and analog communication links.

What is claimed is:

1. A method of data processing in a data processing system having an associated display device and a graphical user interface presented therein, said method comprising:
receiving a focus change request from an application of the data processing system requesting focus of the graphical user interface;
in response to receipt of the focus change request, delaying granting of the focus change request for a predetermined interval following a last user-generated keyboard event; and
following elapsing of the predetermined interval, granting the focus change request, such that the application is awarded focus of the graphical user interface.

2. The method of claim 1, wherein said delaying comprises:
recording a timestamp of a most recent keyboard event; and
delaying granting of said focus change request until a time elapsed since that indicated by said timestamp is greater than or equal to said predetermined interval.

3. The method of claim 1, wherein:
said application is a first application; and
receiving a focus change request comprises receiving a request to change focus of said graphical user interface from a second application to said first application.

4. The method of claim 1, wherein:
said application has a first graphical component and a second graphical component associated therewith; and
receiving a focus change request comprises receiving a request to change focus of said graphical user interface from the first graphical component to said second graphical component.

5. The method of claim 1, and further comprising:
buffering a delayed focus change request until said predetermined interval following a last user-generated keyboard event has elapsed.

6. The method of claim 5, wherein said buffering comprises recording said delayed focus change request in an ordered queue.

7. A program product, comprising:
a computer-readable medium; and
program code within the computer-readable medium that causes a data processing system having an associated display device and a graphical user interface presented therein to perform a method including:
receiving a focus change request from an application of the data processing system requesting focus of the graphical user interface;
in response to receipt of the focus change request, delaying granting of the focus change request for a predetermined interval following a last user-generated keyboard event; and
following elapsing of the predetermined interval, granting the focus change request, such that the application is awarded focus of the graphical user interface.

8. The program product of claim 7, wherein the program code further causes the data processing system to record a timestamp of a most recent keyboard event and delay granting of said focus change request until a time elapsed since that indicated by said timestamp is greater than or equal to said predetermined interval.

9. The program product of claim 7, wherein:
said application is a first application; and
the focus change request requests a change in focus of the graphical user interface from a second application to said first application.

10. The program product of claim 7, wherein:
said application has a first graphical component and a second graphical component associated therewith; and
the focus change request requests a change in focus of said graphical user interface from the first graphical component to said second graphical component.

11. The program product of claim 7, wherein the program code further buffers a delayed focus change request until said predetermined interval following a last user-generated keyboard event has elapsed.

12. The program product of claim 11, wherein said program code buffers the delayed focus change request in an ordered queue.

13. A data processing system, comprising:
a processor unit;
an adapter for a display device coupled to the processor unit;
an input/output interface for a keyboard;
a computer-readable medium coupled to the processor unit; and
program code within the computer-readable medium that causes the data processing system to perform a method including:
receiving a focus change request from an application of the data processing system requesting focus of a graphical user interface presented within the display device;
in response to receipt of the focus change request, delaying granting of the focus change request for a predetermined interval following receipt of a last user-generated keyboard event; and
following elapsing of the predetermined interval, granting the focus change request, such that the application is awarded focus of the graphical user interface.

14. The data processing system of claim 13, wherein the program code further causes the data processing system to record a timestamp of a most recent keyboard event and delay granting of said focus change request until a time elapsed since that indicated by said timestamp is greater than or equal to said predetermined interval.

15. The data processing system of claim 13, wherein:
said application is a first application; and
the focus change request requests a change in focus of the graphical user interface from a second application to said first application.

16. The data processing system of claim 13, wherein:
said application has a first graphical component and a second graphical component associated therewith; and
the focus change request requests a change in focus of said graphical user interface from the first graphical component to said second graphical component.

17. The data processing system of claim 13, wherein the program code further buffers a delayed focus change request until said predetermined interval following a last user-generated keyboard event has elapsed.

18. The data processing system of claim 17, wherein said program code buffers the delayed focus change request in an ordered queue.

19. The data processing system of claim 17, and further comprising the display device.
